(19) United States
(12) Patent Application Publication
(10) Pub. No.: US 2004/0104498 A1
(43) Pub. Date: Jun. 3, 2004

(54) Tubular sleeve insert for creating a void in precast concrete

(76) Inventor: David Schneider, Ephrata, PA (US)

Correspondence Address: SAMUEL W. APICELLI, DUANE MORRIS LLP, 305 NORTH FRONT STREET, P.O. BOX 1003, HARRISBURG, PA, 17108-1003, US

(21) Appl. No.: 10/307,639

(22) Filed: Dec. 2, 2002

(51) Int. Cl. B28B 7/34; B28B 7/18

(52) U.S. Cl. 264/31; 249/61; 249/96; 249/177; 249/184

(57) ABSTRACT

An insert is provided for forming a void in precast concrete that includes a tube defined by a wall and having a plurality of formed, longitudinally spaced-apart ribs that project radially outwardly from an outer surface of the wall. A plurality of corresponding recesses are defined in an interior surface of the wall. A plurality of score lines are positioned between the ribs so that the tube may be adjusted in length to meet the particular requirements associated with a specific design of precast concrete. At least one removable cap is positioned in an open end of the tube so as to prevent concrete from entering the tube during casting. A method for forming a void within a precast concrete structure is also provided in which the tubular sleeve assembly is positioned within a form containing uncured concrete, and one or more of the score lines are cut so as to adjust the length of the tube.

### FIELD OF THE INVENTION

The present invention generally relates to prefabricated building materials, and more particularly, to devices used in the manufacture of precast concrete structural elements.

### BACKGROUND OF THE INVENTION

Conventional commercial construction projects, e.g., parking garages, commercial buildings, stadiums, bridges, overpasses and the like, have often involved the on site formation of a series of temporary forms for casting reinforced concrete structural members, which forms are later removed once the concrete has cured. This is generally a relatively long and drawn out process, as it is necessary initially to construct the temporary foundation forms, then wait for the concrete to cure before forming further concrete structures above the foundations, with a further delay for curing before finally forming the pier caps and upper structure.

It has become known in the art to manufacture such commercial structures from precast concrete building elements, such as, columns, walls, stairs, architectural concrete facades, insulated wall panels, beams, stadium risers, double tees, girders, spandrel beams, floor slabs, and the like. During manufacture, it is customary to provide voids (e.g., tunnels or passageways) within these building elements for embedding posts and fasteners or inserting portions of other precast structural elements, when assembling and solidly anchoring them together to form a portion of a commercial structure. The voids are not typically utilized until the concrete has hardened or cured to a desired state, and the precast structural element is delivered to a construction site. It is often the case that the void may be exposed to rainfall, or there may be an accumulation of particles of foreign matter in the void which will interfere with insertion of other pieces into the void. As a result, it is often necessary to close off the void prior to use.

Various methods and apparatus are known in the prior art for creating such voids in poured concrete. For example, voids may be provided at the construction site by simply core drilling the structure at the time. Such a procedure may be difficult to control accurately, and is often very costly.

In U.S. Pat. No. 1,954,788, issued to Chambliss, Jr. et al., an aperture-forming mold is disclosed for the construction of concrete floors, walls, and the like with apertures or openings therein for wires, piping, and other desired purposes.

U.S. Pat. No. 3,020,615, issued to Peters, relates generally to conduit molding forms such as are used by cement contractors, construction workers and the like for facilitating rapid removal of the core from a molded conduit. Peters' molding form is arranged so as to avoid becoming bonded to the concrete, and permits removal of the form without the use of special tools. The form can be cut to different lengths, as needed, for a particular molding operation.

U.S. Pat. No. 3,205,634, issued to Wagner, discloses post sleeves for concrete foundations that are used to facilitate erection of structures by inserting posts, legs, or other parts within the sleeves.

U.S. Pat. No. 3,265,349, issued to Hamrick, discloses the formation of a passageway through a poured concrete structure, such as a wall or a floor using a metal sleeve mold. This type of metal sleeve can cause corrosion problems. Also, if the metal sleeve be set out of square alignment, as can easily occur, an embedded item would be prevented from fitting into the void properly. Corrective action would be to chip away the concrete around the metal sleeve and then burn the sleeve out with a cutting torch.

U.S. Pat. No. 3,933,336, issued to Tolf, Jr., discloses a pipe sleeve used to form a hole when pouring a concrete slab. The pipe sleeve includes a tubular side wall having an end wall closing one end and a radially outwardly extending flange at the other end. Longitudinally extending ribs are formed on the outside surface of the side wall, and a plurality of grooves are formed in the inner surface of this side wall. The side wall is tapered, and due to this taper, the pipe sleeves may be compactly stacked for storage or for shipping purposes. The sleeve may be used either in its original length or in a shorter length by cutting the side wall to a desired length and then telescoping the two cut sections together. When stacked for shipping or storage, the ribs are located in the grooves, but when two cut sections are telescoped, the ribs are out of the grooves and tightly bind the two sections together.

U.S. Pat. No. 4,515,271, issued to Auciello et al., discloses forming a void in poured concrete using a tubular structure formed of sheet material closed at upper and lower ends by means of an upper closure element and a lower closure element, respectively. The inner surface of the tubular structure presents a helical score line extending between the bottom of the tubular structure and the upper closure element. The upper closure element is formed integrally with the tubular sheet material and constructed at an upper side with tabs for handling the insert and especially for lifting the upper closure element and pulling away the tubular structure along the score line to leave a void. The tubular structure consists of a tapered configuration which decreases in size from the bottom to the top. This tapered construction allows a plurality of the tubular inserts to be arranged in nested relationship with the holder tab being operable to maintain upper closure elements of the nested inserts spaced away from one another.

Because none of the prior art devices are completely satisfactory, there exists a need for a better way of forming voids in precast concrete structural building elements.

### SUMMARY OF THE INVENTION

The present invention provides an insert for forming a void in precast concrete. A preferred embodiment includes a tube defined by a wall and having a plurality of formed, longitudinally spaced-apart ribs that project radially outwardly from an outer surface of the wall. A plurality of corresponding recesses are defined in an interior surface of the wall and are accessible from an interior portion of the tube. Advantageously, a plurality of score lines are positioned between the ribs so that the tube may be adjusted in length to meet the particular requirements associated with a specific design of precast concrete. At least one removable cap is positioned in an open end of the tube so as to prevent concrete from entering the tube during casting.

A method for forming a void within a precast concrete structure is also provided in which a tubular sleeve assembly is positioned within a form containing uncured concrete, where the tubular sleeve assembly comprises an open ended tube defined by a wall with a plurality of formed, longitudinally spaced-apart ribs that project radially outwardly from an outer surface of the wall. A plurality of corresponding recesses are defined in an interior surface of the wall that are accessible from an interior portion of the tube. A plurality of score lines are formed between the ribs, one or more of which may cut so as to adjust the length of the tube. A removable cap is positioned in each open end of the tube so as to prevent the ingress of concrete during manufacture.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view of a tubular sleeve assembly formed in accordance with the present invention;

FIG. 2 is an exploded perspective view of the tubular sleeve assembly shown in FIG. 1;

FIG. 3 is an exploded cross-sectional view of the tubular sleeve assembly shown in FIG. 2;

FIGS. 4 and 5 are broken-away cross-sectional views of the end portions of the tubular sleeve assembly of the present invention;

FIGS. 6 and 7 are broken-away cross-sectional views of the ends of the tubular sleeve assemblies shown in FIGS. 4 and 5, with the end caps positioned within the tube;

FIG. 8 is a broken-away perspective view of a concrete form having two tubular sleeve assemblies formed in accordance with the present invention positioned within the form;

FIG. 9 is a broken-away cross-sectional view of cured precast concrete structure including the tubular sleeve assembly shown in FIG. 8, as taken along the lines 9-9 in FIG. 8;

FIG. 10 is a broken-away enlarged cross-sectional view of the precast concrete structure and tubular sleeve assembly shown in FIG. 9, illustrating the removal of a portion of the tube;

FIG. 11 is a broken-way cross-sectional view of a precast concrete structure having a tubular sleeve assembly formed in accordance with the present invention positioned within the structure; and

FIG. 12 is a broken-away cross-sectional view similar to FIG. 11, showing a method of transporting the precast concrete structure member utilizing the tubular sleeve assembly of the present invention.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

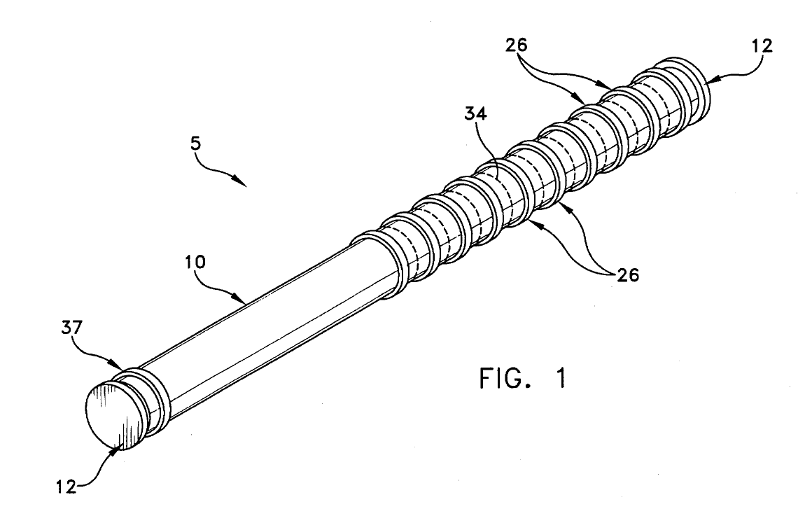

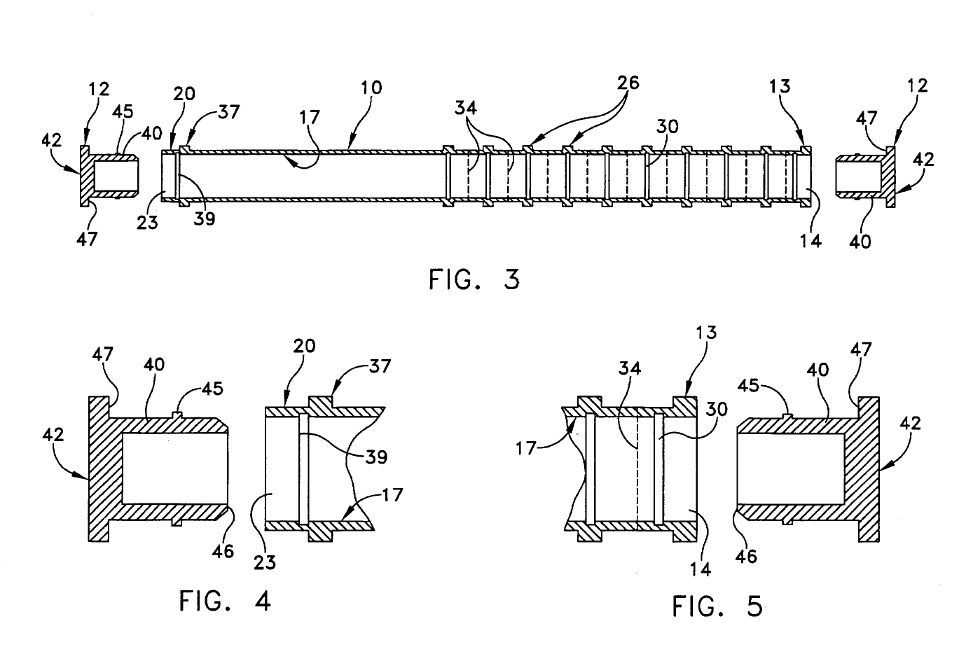

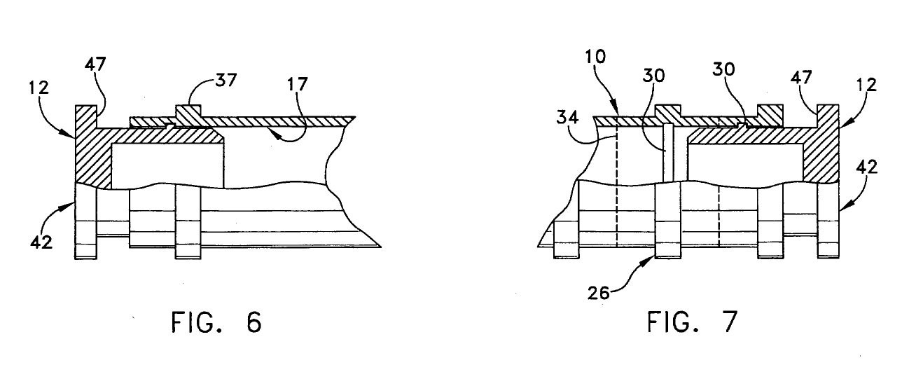

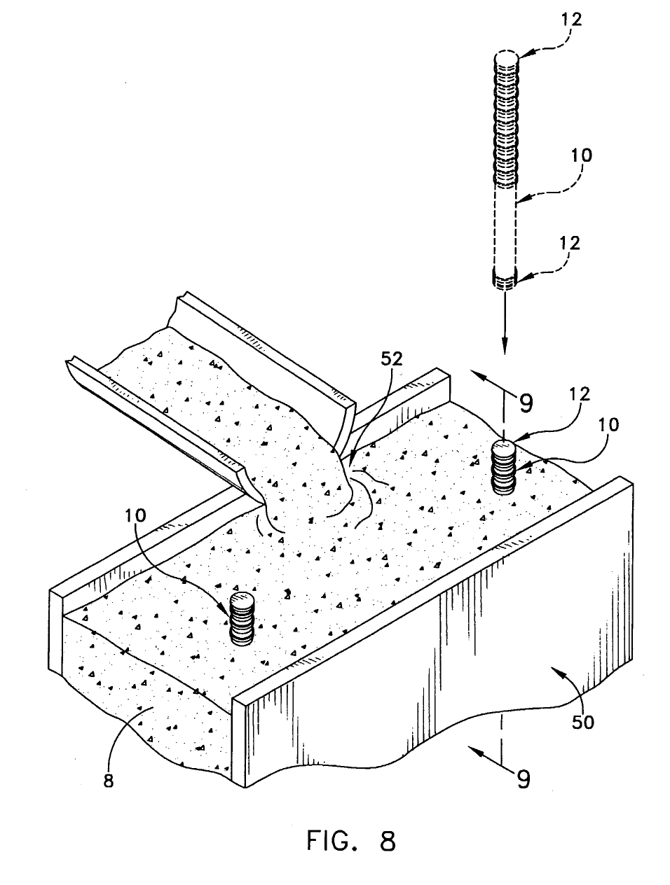

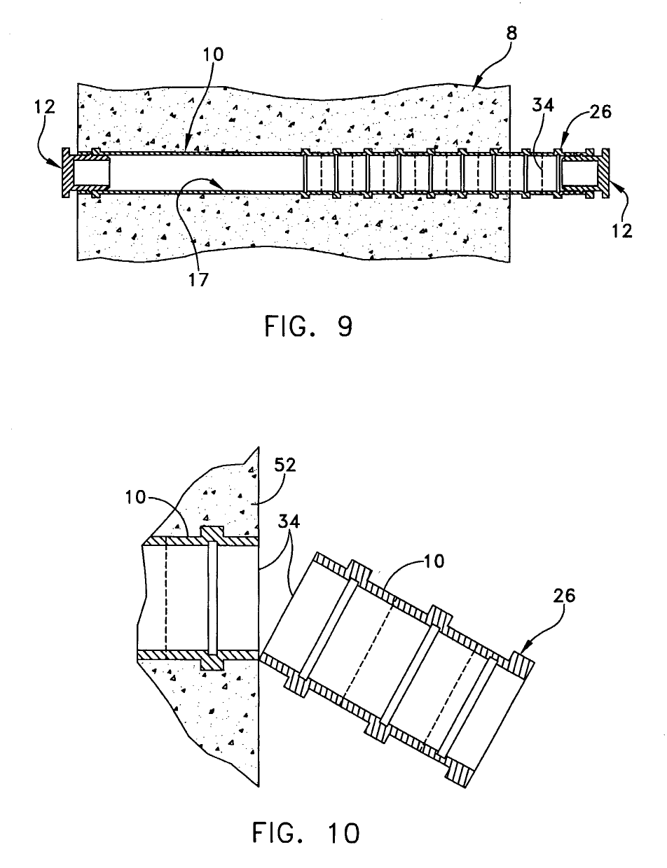

Referring to FIGS. 1-5, a tubular sleeve assembly 5 formed in accordance with the present invention, and adapted for the creation of a void in a precast concrete structure 8 (FIG. 9), comprises an elongate tube 10 and a pair of end caps 12. Tube 10 includes a first end 13 having an opening 14 that leads into a central passageway 17. Tube 10 also includes a second end 20 having an opening 23 that leads into central passageway 17. Tube 10 is often molded from a polymer material so as to comprise a circular cross-section with a diameter of about three inches. Polymeric materials useful in this invention include any material useful in the construction industry, including, without limitation, thermoplastics (crystalline or non-crystalline, cross-linked or non-cross-linked), thermosetting resins, elastomers or blends or composites thereof. Illustrative examples of useful thermoplastic polymers include, without limitation, polyolefins, such as polyethylene or polypropylene, copolymers (including terpolymers, etc.) of olefins such as ethylene and propylene, with each other and with other monomers such as vinyl esters, acids or esters thereof -unsaturated organic acids or mixtures thereof, halogenated vinyl or vinylidene polymers such as polyvinyl chloride, polyvinylidene chloride, polyvinyl fluoride, polyvinylidene fluoride and copolymers of these monomers with each other or with other unsaturated monomers, polyesters, such as poly(hexamethylene adipate or sebacate), poly(ethylene terephthalate) and poly(tetramethylene terephthalate), polyamides such as Nylon-6, Nylon-6,6, Nylon-6,10, Versamids, polystyrene, polyacrylonitrile, thermoplastic silicone resins, thermoplastic polyethers, thermoplastic modified cellulose, polysulphones and the like.

A plurality of spaced-apart ribs 26 are formed along a first portion of first end 13 so as to project radially outwardly from the outer surface of tube 10. As a result of this construction, a plurality of recesses 30, that correspond to plurality of spaced-apart ribs 26, are defined by the inner surface of tube 10. Ribs 26 are typically spaced apart by about two inches. A plurality of score lines 34 are formed in the surface of tube 10, i.e., a circumferential groove or weakening of the tube that is molded or cut (scored) into the surface of tube 10. One scoreline 34 is formed between each pair of adjacent ribs 26 so as to be positioned at predetermined intervals along the length of the first portion of first end 13. A single rib 37 is formed in second end 20 of tube 10 adjacent to, but spaced from the edge of tube 10 that defines opening 23. A recess 39, adjacent to single rib 37, is defined by the inner surface of tube 10. The transverse center-line of single rib 37 is spaced away from the edge of tube 10 by a distance that is substantially equal to the distance from a score line 34 to the transverse center-line of an adjacent rib 26.

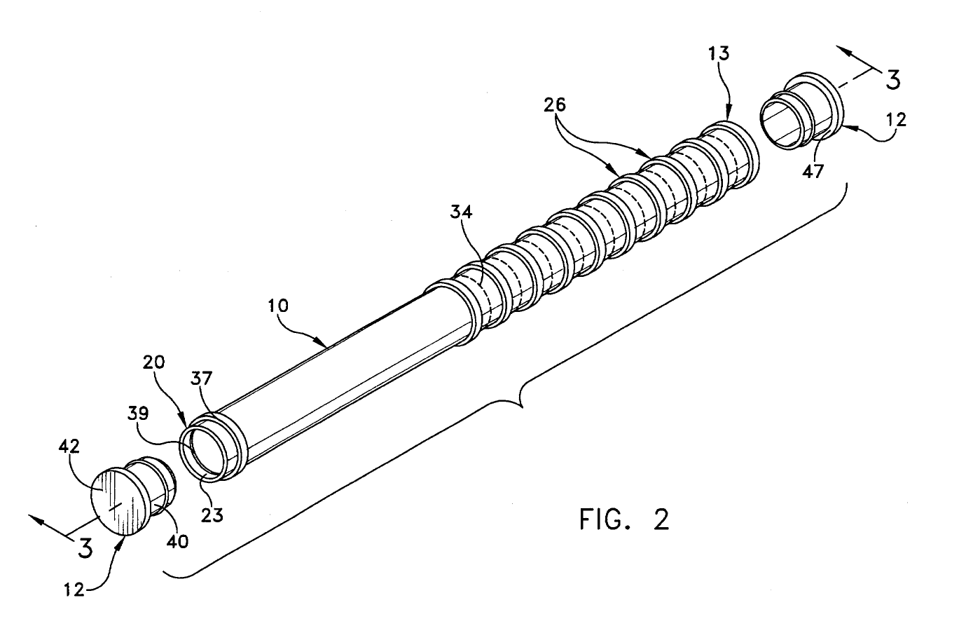

Referring to FIGS. 2-5, end caps 12 comprise a cylindrical body 40, a end wall 42, and an annular snap-rib 45. More particularly, cylindrical body 40 is often hollow, with an open end edge 46. The-outer diameter of cylindrical body 40 is somewhat smaller than the inner diameter of tube 10. End wall 42 is disposed at one end of cylindrical body 40, and is sized so as to form a brim 47 that projects radially outwardly from the end edge of cylindrical body 40. Snap-rib 45 projects radially outwardly from cylindrical body 40 in spaced relation to brim 47, and adjacent to, but spaced from end edge 46.

Advantageously, snap-rib 45 is sized and shaped to be received within one of recesses 30 or 39, i.e., the transverse center-line of snap-rib 45 is spaced away from end edge 46 by a distance that is substantially equal to the distance from a score line 34 to the transverse center-line of an adjacent rib 26 or, from the end edge of end 20 to recess 39.

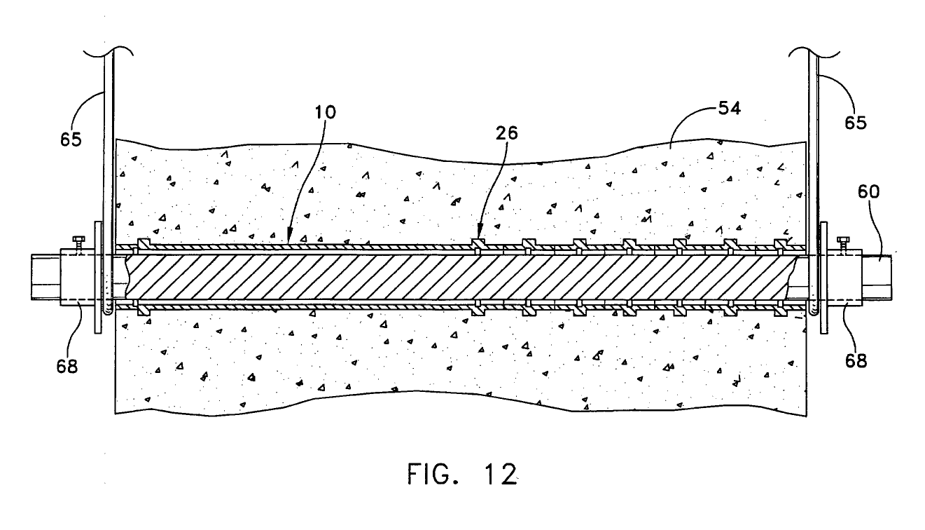

Referring to FIGS. 8-12, tubular sleeve assembly 5 is arranged with end caps 12 assembled in opening 14 of first end 13 and opening 23 of second end 20 so as to prevent ingress of concrete during placement within form 50. To begin, an end cap 12 is arranged in confronting coaxial relation with second end 20 of tube 10 such that open end edge 46 is positioned adjacent to opening 23. Once in this position, end cap 12 is moved toward tube 10 so that edge 46 enters opening 23 of tube 10. End cap 12 continues into tube 10 until annular snap-rib 45 slips into and is captured by recess 39 corresponding to single rib 37. A second end cap 12 is then arranged in coaxially confronting relation to first end 13 such that open end edge 46 is positioned adjacent to opening 14. Once in this position end cap 12 is moved toward tube 10 so that open end edge 46 enters tube 10 until snap-rib 45 engages the recess 30 adjacent to the end tube 10. As this occurs, brim 47 engages the open end edge of first end 13.

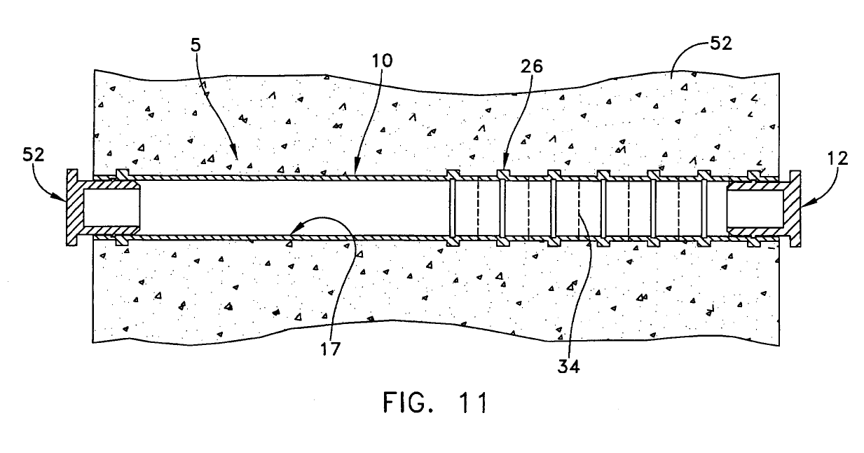

Tubular sleeve assembly 5 is used during the manufacture of a precast concrete structure 8, to create a useable void in the structure, in the following manner. A form 50, that comprises the shape of a structural element, e.g., a column, wall, stair, beam, riser, double tee, girder, spandrel beam, or floor slab, is filled with uncured concrete 52 in a conventional manner (FIG. 8). A plurality of reinforcing materials or pre-stressing cables or rods (not shown) may be positioned within form 50 so as to precondition the precast concrete structure 8. Either prior to pouring of the uncured concrete, or while the concrete is still in a plastic state, one or more tubular sleeve assemblies 5 are positioned within concrete 52 at predetermined locations along the length, or through the width, of the forming structure. Advantageously, the length of tubular sleeve 5 may be adjusted to accommodate a wide variety of widths and thicknesses by cutting tube 10 along a score line 34 so as shorten the tube to a desired length (FIG. 10). Tube 10 may be cut to the appropriate length for the particular structural element being precast, and then sunk into concrete 52 within form 50, or tube 10 may be cut to size once concrete 52 has cured to a more solid state.

Tubular sleeve assembly 5, with one or both end caps 12 assembled to it, are arranged within form 50 at the pre-selected locations so that either first end 13 or second end 20 stand proud of the surface of concrete 52. As a result, central passageway 17 of tube 10 is isolated from concrete 52. With end caps 12 in place, tubular sleeve assembly 5 is also protected from the environment so as to remain in a pristine configuration for final use during assembly of precast concrete structure 8. When access is needed to central passageway 17, end caps 12 are merely removed to open tube 10 for use.

In one embodiment of the present invention, a precast concrete structure 54 may be lifted or otherwise moved by first removing end caps 12 from tube 10, and inserting a steel rod 60 through central passageway 17 (FIG. 12). A pair of hooks or eyelets 65 are then clipped over the exposed ends of rod 60 followed by clamps 68 which are adapted to be releasably fastened onto rod 60 so as to hold hooks 65 in place. Once this construction is completed, a conventional hoist, crane, or other means for lifting heavy objects may be employed to grasp hooks 65 and move precast concrete structure 54 to an appropriate location. Once in location, releasable clamp 68 may be removed along with hooks 65 and steel rod 60 thus positioning precast concrete structure 54 in place. End caps 12 may or may not be replaced in tube 10 once precast concrete structure 54 is in it's final position.

It is to be understood that the present invention is by no means limited only to the particular constructions herein disclosed and shown in the drawings, but also comprises any modifications or equivalents within the scope of the claims.

What is claimed is:

1. An insert for forming a void in precast concrete comprising:
a tube defined by a wall and having a plurality of formed, longitudinally spaced-apart ribs that project radially outwardly from an outer surface of said wall and a plurality of corresponding recesses defined in an interior surface of said wall and accessible from an interior portion of said tube and further comprising a plurality of score lines positioned between said ribs; and
at least one removable cap positioned in an open end of said tube.

2. An insert according to claim 1 wherein said tube is molded from a polymer material so as to comprise a circular cross-section with a diameter of about three inches.

3. An insert according to claim 1 wherein said plurality of spaced-apart ribs are formed along a first portion of said tube.

4. An insert according to claim 1 wherein said ribs are spaced apart by about two inches.

5. An insert according to claim 3 wherein said a single rib is formed in a second portion of said tube adjacent to, but spaced from a free edge of said tube and a corresponding recess is formed adjacent to said single rib in an inner surface of said tube.

6. An insert according to claim 5 wherein said a transverse center-line of said single rib is spaced away from said edge of said tube by a distance that is substantially equal to the distance from one of said score lines to a transverse center-line of an adjacent rib in said first portion.

7. An insert according to claim 1 wherein said tube comprises two open ends, and comprising an end cap positioned within each open end.

8. An insert according to claim 7 wherein each of said end caps comprises a hollow cylindrical body having an open end edge, an end wall, and an annular snap-rib wherein an outer diameter of said cylindrical body is somewhat smaller than an inner diameter of said tube and further wherein said end wall is disposed at one end of said cylindrical body, and is sized so as to form a brim that projects radially outwardly.

9. An insert according to claim 8 wherein said annular snap-rib projects radially outwardly from said cylindrical body in spaced relation to said brim, and adjacent to, but spaced from said open end edge.

10. An insert according to claim 9 wherein said snap-rib is positioned on said cylindrical body so that a transverse center-line of said snap-rib is spaced away from said end edge by a distance that is substantially equal to a distance from at least one of said score lines to a transverse center-line of an adjacent rib.

11. A method for forming a void within a precast concrete structure comprising:
positioning an open ended tubular sleeve assembly within a form arranged for molding a precast concrete object, wherein said tubular sleeve assembly comprises an open ended tube defined by a wall and having a plurality of formed, longitudinally spaced-apart ribs that project radially outwardly from an outer surface of said wall and a plurality of corresponding recesses defined in an interior surface of said wall and accessible from an interior portion of said tube and further comprising a plurality of score lines positioned between said ribs;
pouring uncured concrete into said form such that a portion of said tube stands proud of a top surface of said uncured concrete;
curing said concrete; and
cutting at least one score line of said tube so as to adjust the length of said tube so as to be wholly within said concrete.

12. A method according to claim 12 wherein a removable cap is positioned in each open end of said tube prior to positioning said tube in said uncured concrete.

13. A method according to claim 12 wherein a removable cap is positioned in each open end of said tube after positioning said tube in said uncured concrete.
